(19) United States
(12) Patent Application Publication
(10) Pub. No.: US 2002/0047357 A1
(43) Pub. Date: Apr. 25, 2002

(54) SUPPORT PLINTH FOR A POWER DIODE IN A MOTOR VEHICLE ALTERNATOR

(76) Inventor: JEAN GAUTIER, SAINT BARTHELEMY D'ANJOU (FR)

Correspondence Address: JOSEPH A CALVARUSO ESQ, MORGAN & FINNEGAN LLP, 345 PARK AVENUE, NEW YORK, NY, 101540053

(21) Appl. No.: 09/149,424

(22) Filed: Sep. 8, 1998

(30) Foreign Application Priority Data
Sep. 8, 1997 (FR) 97 11133

(51) Int. Cl. H02K 11/00

(52) U.S. Cl. 310/68 D

(57) ABSTRACT

A motor vehicle alternator includes a support having a hole which receives a plug portion of a support plinth on which a power diode is welded or soldered, the plinth having an axis along which it is force-fitted in the hole. The plinth also has an abutment portion projecting radially from the plug portion with respect to the axis.

### FIELD OF THE INVENTION

This invention relates to plinths for supporting mounting diodes, in particular power diodes constituting a rectifier bridge, in a machine such as an alternator, especially for motor vehicles.

### BACKGROUND OF THE INVENTION

It is known from French patent specification No. FR 2 737 618A to mount a diode on a support plinth or base which is generally in the form of a thick disc. One end of the diode is welded (or soldered) to one face of the plinth. The plinth is then force-fitted into a hole in a heat sink, or dissipator, of an alternator, from one side of the heat sink that faces towards the stator of the alternator, with the diode being finally disposed on a side of the dissipator which is opposite to the stator. This arrangement of diode and plinth has the advantage that it is thus possible to fix diodes at will to the same heat sink, whether they are adapted for either direct force-fitting, or for welding (soldering), the diodes having in the latter case been previously secured to a support plinth or base. With a view to precise axial positioning of each diode in the corresponding hole, the diode has to be introduced from a side of the heat sink which is directed towards the stator. However, this handling operation is in general a very delicate one to carry out, because of the configuration of the alternator on the same side of the heat sink as the stator.

### DISCUSSION OF THE INVENTION

One object of the invention is to make it easier to fit the diode in place, while retaining the advantage described above.

According to the invention, a support plinth for a diode adapted to be soldered or welded in place, the plinth being adapted to receive a diode housing welded to it, the plinth comprising a plug portion adapted to be force-fitted into a hole in a support along an axis of the plinth, is characterised in that the plinth includes an abutment portion projecting from the plug portion in a direction radial to the axis.

Thus, the abutment portion is adapted to come into engagement against the support during fitting of the diode. In this way, precise axial positioning of the diode with respect to the support is obtained. In an alternator, this plinth makes it possible to fit the diode from the opposite side of the support from the stator. Fitting of the diode is thereby made easier. In addition the plinth enables the diode to be fitted in a hole which is blind towards the stator. Moreover, there is no danger of the diode being altered while being fitted.

The abutment portion preferably has an upper engagement face which is oriented away from the abutment portion of the plinth and which defines a flat upper abutment zone perpendicular to the axis. In this way the plinth is well adapted for engagement by a force-fitting tool.

Preferably, the plinth has a cavity which is adapted to receive the diode, with the upper engagement face projecting from the cavity in the axial direction. The assembly consisting of the diode and the plinth is therefore very small in the axial direction.

The abutment portion preferably has a lower abutment face which is oriented towards the abutment portion and which defines a flat lower abutment zone at right angles to the axis.

The invention also provides an assembly consisting of a diode and a support plinth, with the diode comprising a housing fixed to the plinth, the latter being a plinth according to the invention. The abutment portion is then preferably interposed in the axial direction between the diode and the plug portion of the plinth. This configuration is particularly well suited to an assembly operation carried out from the opposite side of the support from the stator. The abutment portion preferably projects from the diode in the direction radial to the axis.

In addition, according to a further aspect of the invention, an alternator, especially for a motor vehicle, comprises a support and an assembly consisting of a diode and a plinth, the plinth being fixed to the diode and force-fitted in a hole in the support, the assembly being in accordance with the invention as defined above. The abutment portion preferably extends on one side of the support, opposite to a stator of the alternator. The plug portion is preferably force-fitted in a blind hole in the support.

Further features and advantages of the invention will appear more clearly on a reading of the following detailed description of a preferred embodiment of the invention, which is given by way of non-limiting example only and with reference to the accompanying drawings.

### BRIEF DESCRIPTION OF THE DRAWINGS

FIG. 1 is a view in elevation, in partial axial cross section, of an assembly according to the invention comprising a support plinth and a diode.

FIG. 2 is a view in cross section of the assembly shown in FIG. 1, mounted in a support which consists of a bearing of an alternator, this view also showing the assembly tool.

### DESCRIPTION OF A PREFERRED EMBODIMENT OF THE INVENTION

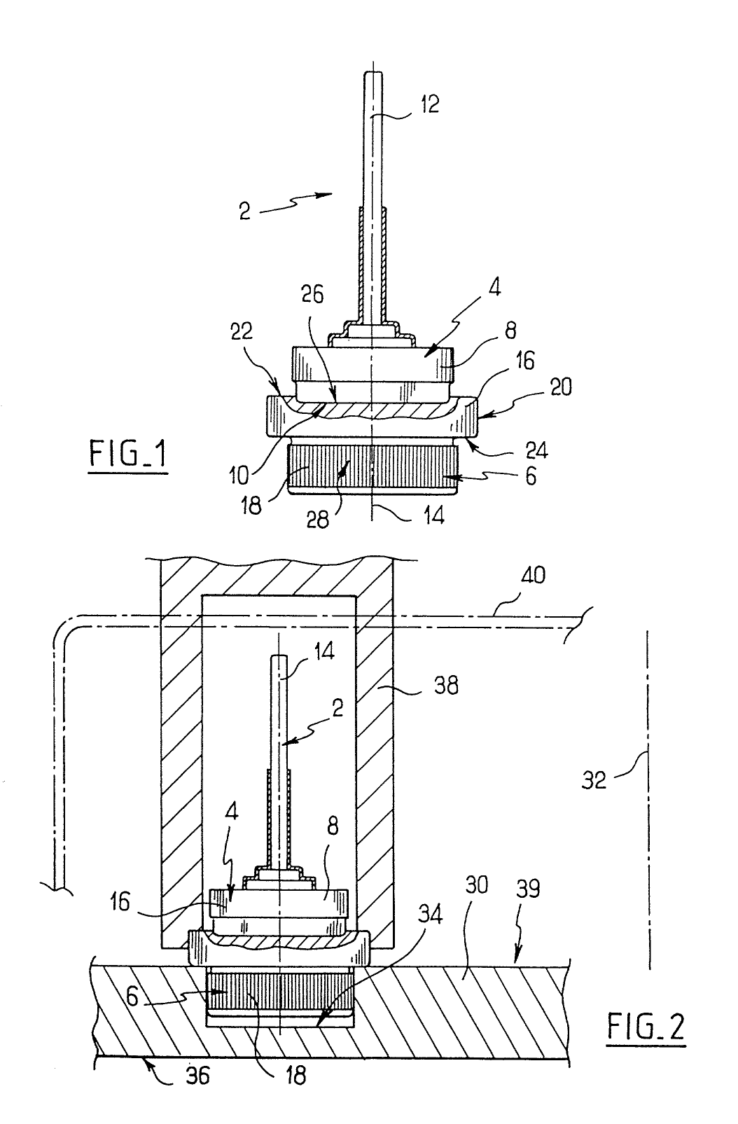

With reference to FIG. 1, the assembly 2 in this embodiment of the invention comprises a diode 4 and a support base or plinth 6. The diode 4 is a conventional power diode adapted to be welded (or soldered) in place. It comprises a metallic housing 8 which encloses a semiconductor component. The housing 8 defines a form of revolution about an axis of symmetry, and has a flat circular face 10, which in this example is its lower face and which constitutes a connecting terminal for the diode. The diode has another connecting terminal 12, which is elongate in form and coaxial with the housing 8, the terminal 12 being opposed to the face 10 in the axial direction.

The plinth 6 is symmetrical as a body of revolution about an axis 14. It comprises an abutment portion 16 and a plug portion 18, each of which is in the form of a thick disc. The plinth is made of an electrically conductive metal, and consists of a single piece.

The abutment portion 16 has a cylindrical side face 20, an annular, flat upper face 22, and an annular, flat lower face 24, both of which are contiguous to the side face 20. In the centre of the upper face 22, the abutment portion 16 has a cavity with a flat base 26 which lies at right angles to the axis 14. Thus the upper face 22 projects from the base 26 of the cavity in the direction of the axis 14.

The plug portion 18 of the plinth has a cylindrical side face 26 which is formed with ridges or knurls parallel to the axis 14. The plug portion 18 has a radius smaller than that of the side face 20 of the abutment portion 16, so that as a result the abutment portion projects from the plug portion in the direction which is radial to the axis 14. The diode 4 lies in the cavity, and the lower face 10 of the housing 8 is welded to the base 26 of the cavity, the diode 4 and the plinth 6 being coaxial with each other. The radius of the abutment portion 16 is greater than the largest radius of the diode 4, so that the abutment portion projects from the diode in the direction radial to the axis 14.

Referring now to FIG. 2, the diode 4 and the plinth 6 are designed to form part of a motor vehicle alternator. The alternator has a rear bearing 30, at the opposite end of the machine from the alternator pulley. The rear bearing lies in a general plane which is at right angles to the axis 32 of the alternator, the direction of which is indicated in FIG. 2.

The alternator includes a series of power diodes 4 which constitute a rectifier bridge. The diode 4 described above forms part of this bridge. Each diode is associated with a plinth 6. The assemblies consisting of a plinth 6 and diode 4 are fixed to the rear bearing 30 (which in the present case also serves as a dissipator of heat), and for that purpose the bearing 30 has circular holes 34 with an axis parallel to the axis 32. The holes 34 are for example blind holes, being obturated on one side 36 of the bearing, this being the side which is oriented towards the stator of the alternator. The bearing can thus constitute a sealed partition.

In order to secure the diode 4 to the bearing 30, the diode 4 is welded or soldered to the plinth 6. The assembly is then placed on a force-fitting tool 38. One end of the tool comes into abutment against the side face 20 and the upper face 22 of the abutment portion 16 of the plinth. The diode and the plinth are presented from one side 39 of the bearing opposite to the stator, the base 6 and the hole 34 being coaxial. By means of the tool 38, the plug portion 16 is force-fitted into the hole 34 until the lower face 24 of the abutment portion 16 comes into engagement against the side 39 of the bearing. The tool is then withdrawn. The diode is now in position, on the side 39 of the bearing opposite to the stator.

Once the alternator has been assembled, the diode 4 lies facing an outer cap 40 of the alternator. This cap is shown in phantom lines in FIG. 2.

Numerous modifications can of course be made to the invention without departing from the scope of the invention. The hole 34 in the bearing may be a through hole. The support for the plinth may be in the form of a dissipator of heat separate from the rear bearing.

The abutment portion of the plinth can be made in a non-circular form, and it also may not even be symmetrical with respect to the axis of the plinth.

What is claimed is:

1. A plinth for supporting a diode having a casing and being further adapted for the diode casing to be welded on the plinth, the plinth including a plug portion adapted to be force-fitted into an aperture and defining an axis of the plinth, wherein the plinth further includes an abutment portion projecting with respect to the plug portion in a direction radial to the said axis.

2. A plinth according to claim 1, wherein the abutment portion has an upper engagement face oriented away from the plug portion and defining a flat upper engagement zone at right angles to the said axis.

3. A plinth according to claim 2, defining a cavity for receiving a said diode, with the upper engagement face projecting from the said cavity in the axial direction.

4. A plinth according to claim 1, wherein the abutment portion has a lower engagement face oriented towards the plug portion and defining a flat lower engagement zone at right angles to the said axis.

5. An assembly comprising a diode having a casing and a plinth according to claim 1, the said casing being fixed to the plinth.

6. An assembly according to claim 5, wherein the abutment portion of the plinth is interposed between the diode and the plug portion in the axial direction.

7. An assembly according to claim 5, wherein the abutment portion of the plinth projects from the diode in a direction radial to the axis.

8. An alternator including a support having a hole, and an assembly according to claim 5 with the plug portion of the plinth force-fitted into the said hole in the support.

9. An alternator according to claim 8 having a stator disposed to one side of the said support, the abutment portion of the plinth being on the other side of the support.

10. An alternator according to claim 8, wherein the said hole is a blind hole.
